(19) United States
(12) Patent Application Publication
(10) Pub. No.: US 2024/0054486 A1
(43) Pub. Date: Feb. 15, 2024

(54) VIRTUAL CURRENCY MANAGEMENT METHOD

(71) Applicants: Ko KIKUCHI, Singapore (SG); Shohei KAMON, Singapore (SG); ETHERSECURITY PACIFIC HOLDINGS PTE LTD., Singapore (SG)

(72) Inventors: Ko KIKUCHI, Singapore (SG); Shohei KAMON, Singapore (SG)

(21) Appl. No.: 17/766,181

(22) PCT Filed: Dec. 19, 2019
(86) PCT No.: PCT/IB2019/061059

§ 371 Date: May 26, 2023

(30) Foreign Application Priority Data
Oct. 1, 2019 (JP) 2019-181765

(51) Int. Cl. G06Q 20/38; G06Q 20/24; G06Q 20/10

(52) U.S. Cl. CPC G06Q 20/381; G06Q 20/24; G06Q 20/10

(57) ABSTRACT

In the present invention, the following are executed: a step for performing processing for converting an amount of a currency A deposited in a first account of a user to a deposit price, which is a price based on a currency X, calculating, in accordance with the converted deposit price, a loan price which is loaned to the user on the security of the currency A in the first account, and depositing, to a second account corresponding to the user, a loan price-equivalent amount of a currency B, which is a virtual currency; a step for performing processing for using the currency B deposited in the second account to manage a staking relating to the currency B; and a step for performing processing for, after the end of the staking, calculating a return price, which is a price based on the currency X and obtained by adding at least interest to the loan price, and paying out, from the second account, an amount of currency B equivalent to the return price.

### TECHNICAL FIELD

The present invention relates to a virtual currency operation method.

### BACKGROUND ART

Conventionally, operations to obtain a reward by mining virtual currencies have been carried out.

### PRIOR ART LIST

### Patent Literature

[Patent Literature 1] Japanese Patent No. 6345871

### SUMMARY OF THE INVENTION

### Technical Problem

Since the consensus method of Proof-of-Work (PoW) consumes a large amount of resources including electricity bills, the proof-of-stake (PoS) is starting to be adopted as the consensus method. However, the staking of proof-of-stake is easy to succeed in minting it depending on the amount of virtual currency held, and it is difficult to operate with a small amount.

The present invention has been made in view of such a background, and an object of the present invention is to provide a technique capable of efficiently operating staking.

### Technical Solution

The main invention of the present invention for achieving the above object is a virtual currency operation method characterized by performing: a step in which a computer performs a process for depositing a second currency, which is a virtual currency equivalent to the first value in the first currency, into the user's account; a step of performing a process for operating staking pertaining to the second currency using the second currency deposited in the account; and a step of performing a process for withdrawing the second currency corresponding to the second value according to the first value from the account after the end of the staking.

Other problems disclosed in the present application and technical solutions thereof will be clarified in the embodiments of the invention and the accompanying figures.

### Advantageous Effects

According to the present invention, the staking can be efficiently operated.

### BRIEF DESCRIPTION OF THE DRAWINGS

FIG. 1 shows the overall configuration example of the staking system of the present embodiment.

FIG. 2 shows the hardware configuration example of the user terminal 1.

FIG. 3 shows the software configuration example of the user terminal 1.

FIG. 4 shows the hardware configuration example of management server 2.

FIG. 5 shows the software configuration example of management server 2.

FIG. 6 is a figure for explaining the operation of the staking system of the present embodiment.

### DETAILED DESCRIPTION OF THE EMBODIMENTS

### Embodiment

The contents of the embodiment of the present invention will be listed and described. The embodiment of the present invention has the following configuration.

### [Item 1]

A virtual currency operation method,
wherein a computer performs:
a step of performing a process for depositing a second currency, which is a virtual currency equivalent to a first value in a first currency, into a user's account;
a step of performing a process for operating staking pertaining to the second currency using the second currency deposited in the account; and
a step of performing a process for withdrawing from the account the second currency corresponding to the second value according to the first value, after the end of the staking.

### [Item 2]

The virtual currency operation method according to item 1,
wherein the computer further performs:
a step, before depositing the virtual currency equivalent to the first value into the account, of converting the amount of the third currency, which is the same or different virtual currency as the second currency deposited in the account, into the third value in the first currency; and
a step of determining the first value according to the third value.

### [Item 3]

The virtual currency operation method according to item 2,
wherein the computer further performs:
a step of, when the balance of the second currency in the account is less than the amount corresponding to the second value after the end of the staking, processing of withdrawing the third currency corresponding to the value of the shortfall from the account.

### [Item 4]

The virtual currency operation method according to item 1,
wherein the computer further performs:
a step of acquiring a predicted value of the balance of the second currency; and
a step of ending the staking when the predicted value is less than or equal to the predetermined value.

### [Item 5]

The virtual currency operation method according to item 4,
wherein the predetermined value is determined according to the first value.

### [Item 6]

The virtual currency operation method according to item 1,
wherein the computer determines the second value based on the statistic value concerning the virtual currency and the first value.

### [Item 7]

The virtual currency operation method according to item 6,
wherein the statistic value includes at least one of the volatility, hash rate, number of transactions, and lock rate, reward rate, exchange-based transaction amount, and market capitalization, pertaining to the virtual currency.

### [Item 8]

The virtual currency operation method according to item 1,
wherein the computer further performs:
a step of selecting the second currency from a plurality of virtual currencies in accordance with at least one of reward rate by staking, exchange-based transaction amount, volatility, hash rate, number of transactions, lock rate, and market capitalization.

### [Item 9]

The virtual currency operation method according to item 1,
wherein the computer further performs:
a step of, after the reward by the staking has been deposited to the account, exchanging the second currency deposited in the account for a virtual currency different from the second currency according to the amount concerning the reward converted into the value of the first currency, and executing a process for operating staking pertaining to the different virtual currency.

### [Item 10]

The virtual currency operation method according to item 1,
wherein the computer performs:
after the end of the staking, a process for paying to the user the first currency corresponding to the balance obtained by subtracting the amount of the second currency corresponding to the fourth value, which is higher than the second value, from the balance of the second currency of the account according to the first value until a lock period elapses; and withdraws the second currency corresponding to the fourth value from the account after the lock period elapses.

### [Item 11]

The virtual currency operation method according to item 1,
wherein the computer performs:
the determination of whether or not to deposit money into the account, depending on the rate of return for the staking concerning the second currency and the interest rate for converting the first value into the second value.

### [Item 12]

The virtual currency operation method according to item 1,
wherein the computer performs:
the determination of whether or not to deposit money into the account, depending on the rate of return by staking pertaining to the second currency, the interest rate for converting the first value into the second value, and the risk tolerance of the user specified in advance.

### [Item 13]

The virtual currency operation method according to item 1,
wherein the virtual currency is a security token.

### [Item 14]

The virtual currency operation method according to item 2,
wherein the computer performs:
a process for operating staking pertaining to the third currency.

### SUMMARY

Now, the staking system according to one embodiment of the present invention will be described. The staking system of the present embodiment attempts to manage assets by using the reward for performing the staking (called mining or casting in PoS) when the Proof-of-Stake (PoS), which is a consensus algorithm, is adopted in the virtual currency using a blockchain. In particular, it is assumed that the currency A (a virtual currency is assumed, but it may be a value other than a virtual currency such as legal currency) deposited by the user in the account is converted into the value of the currency X (a legal currency is assumed, but may be virtual currency), the virtual currency B (may be the same virtual currency as currency A) corresponding to this value is deposited in the user's account, and staking is performed using this virtual currency B. In the present embodiment, it is assumed that the value of the virtual currency B to be deposited is larger than the value of the currency A. The currency A may also be operated by staking. When the operation by staking is ended, a coin corresponding to the amount that has added the interest to the amount obtained by converting the virtual currency B at the time of deposit into currency X are withdrawn (repaid) from the user's account. In this manner, the user can perform staking with the virtual currency B with the amount multiplied by the leverage with the currency A initially deposited in the account as collateral, and the reward for staking and the gain on the price increase of the virtual currency B can be expected as profits for users. The risks for a user includes the rate of repayment of virtual currency B, the price drop of virtual currency B, the rate of return for staking (success rate of staking and the number of transactions), and the lock period of virtual currency B (the period during which coins cannot be moved from the account).

System Configuration

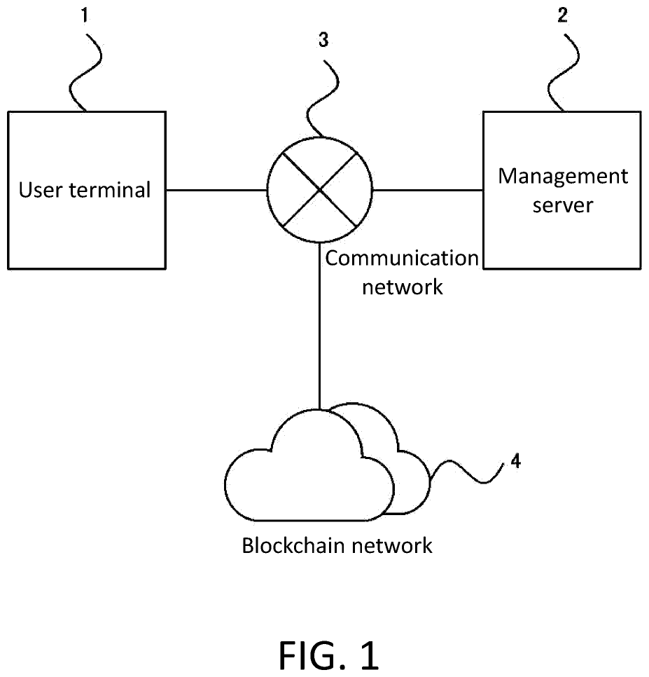

FIG. 1 shows the overall configuration example of the staking system of the present embodiment. As shown in the figure, the staking system of the present embodiment includes a user terminal 1 and a management server 2. The user terminal 1 and the management server 2 are connected to each other so as to be able to communicate with each other via the communication network 3. The communication network 3 is constructed by, for example, a public telephone line network, a mobile telephone line network, a dedicated telephone line network, a wireless communication path, an Ethernet (registered trademark), a serial cable, or the like, for example, the Internet or a LAN (Local Area Network), VAN (Value Added Network), and the like. The user terminal 1 and the management server 2 are also communicably connected to a blockchain network 4. A plurality of blockchain networks 4 may exist according to the type of virtual currency. In the present embodiment, it is assumed that there are two blockchain networks 4 for virtual currency A and virtual currency B.

The user terminal 1 is a computer used by an end user who wants to manage an asset, and is, for example, a smartphone, a tablet computer, a personal computer, and the like. The user can operate the user terminal 1 to perform various financial processes such as deposit and withdrawal pertaining to the account.

The management server 2 is a computer that performs operation management by staking according to the present embodiment. The management server 2 may be, for example, a physical computer such as a personal computer or a workstation, or a virtual computer realized by cloud computing.

==User Terminal 1==

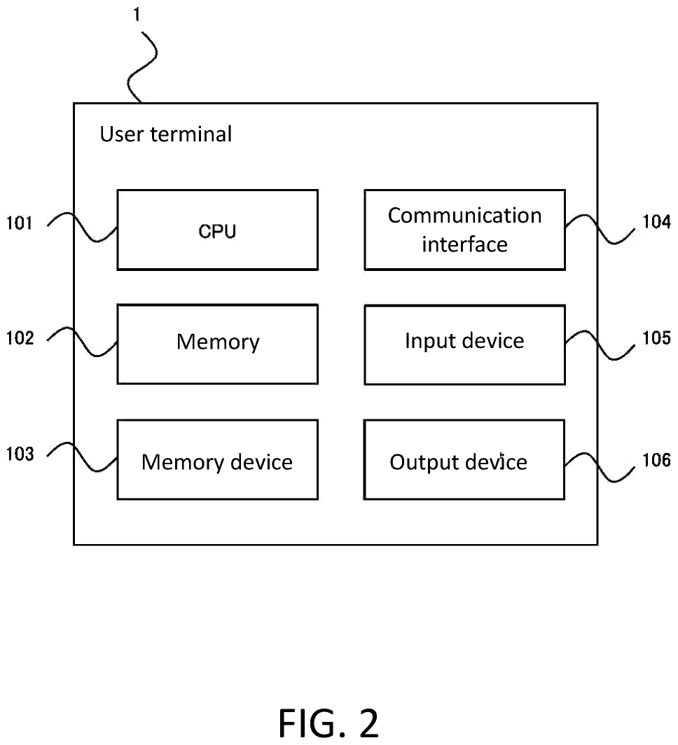

FIG. 2 shows the hardware configuration example of the user terminal 1. The user terminal 1 includes a CPU 101, a memory 102, a storage device 103, a communication interface 104, an input device 105, and an output device 106. The memory device 103 is, for example, a hard disk drive, a solid-state drive, a flash memory, and the like, which stores various data and programs. The communication interface 104 is an interface for connecting to the communication network 3, for example, an adapter for connecting to an Ethernet (registered trademark), a modem for connecting to a public telephone network, a wireless communication device for wireless communication, a USB (Universal Serial Bus) connector and an RS232C connector for serial communication, and the like. The input device 105 is, for example, a keyboard, a mouse, a touch panel, a button, a microphone, or the like that inputs data. The output device 106 is, for example, a display, a printer, a speaker, or the like that outputs data.

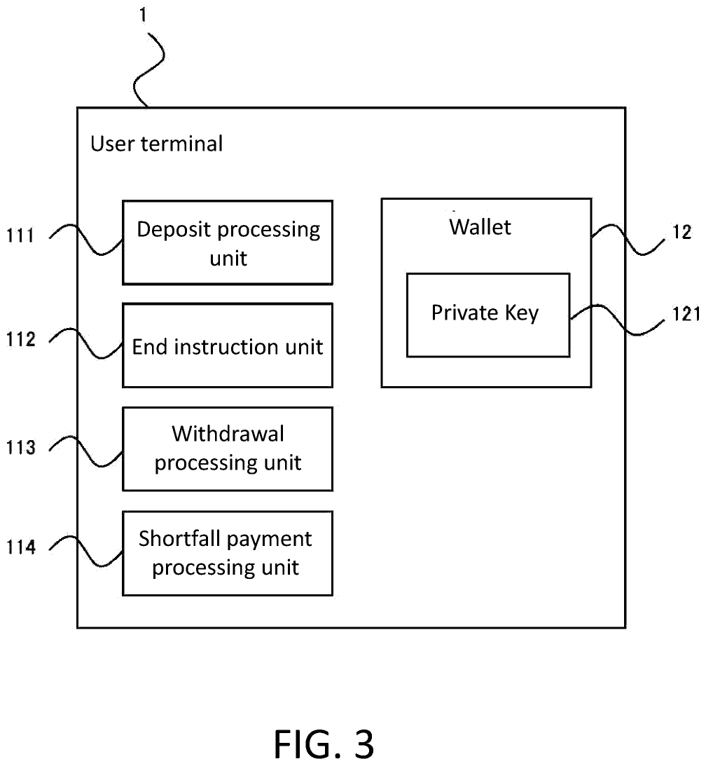

FIG. 3 shows the software configuration example of the user terminal 1. The user terminal 1 includes a wallet 12, a deposit processing unit 111, an end instruction unit 112, a withdrawal processing unit 113, and a shortfall payment processing unit 114, wherein the wallet 12 includes a private key 121.

Further, the wallet 12, the deposit processing unit 111, the end instruction unit 112, the withdrawal processing unit 113, and the shortfall payment processing unit 114 are realized such that the CPU 101 installed in the user terminal 1 reads and executes a program stored in the storage device 103 into the memory 102.

The wallet 12 manages a private key 121 used for the transaction in the blockchain network 4. Further, in the present embodiment, the wallet 12 is assumed to be a contract wallet. That is, a program concerning a transaction (movement of funds) for a user is registered in advance in the blockchain 4. The program is automatically executed for the information (change in the balance of the account, volatility of the virtual currency deposited in the account, hash rate, number of transactions, lock rate, reward rate, exchange-based transaction amount, market capitalization, and the like) about the user's account corresponding to the wallet 12. The program may be executed by a computer constituting the blockchain network 4, or may be executed by the management server 2, or may be executed by the user terminal 1.

The deposit processing unit 111 performs a process for depositing the currency A into the user's account. The deposit processing unit 111 can deposit the currency A into the account, for example, by generating a transaction in the blockchain network 4.

The end instruction unit 112 receives an instruction to end the operation by staking. For example, the end instruction unit 112 may receive an operation end instruction from the user, or may detect as an operation end instruction that a predetermined operation period (lock period) has elapsed. Further, the end instruction unit 112 periodically acquires the value evaluated in the currency X (for example, legal currency) of the currency A, and can detect that the value (collateral value) of the currency A of the account is equal to or less than a predetermined value as an instruction for the end of operation.

The withdrawal processing unit 113 withdraws currency B from the account. The withdrawal processing unit 113 withdraws the amount of currency B (repayment amount) corresponding at the present time (at the time of withdrawal processing by the withdrawal processing unit 113, that is, at the time of repayment) to the amount obtained by adding a predetermined interest equivalent amount to the value of currency B in currency X at the time of deposit from the system. The withdrawal destination is, for example, the account of the system operator specified in advance by the system. Thereby, the amount obtained by adding interest to the appraisal value of the currency B originally lent in the currency X will be repaid by the currency B. The withdrawal processing unit 113 can create a withdrawal transaction in response to an instruction from the management server 2 (hereinafter referred to as a repayment instruction) and instruct money payment to the wallet 12. In the present embodiment, it is assumed that the repayment amount is set in the repayment instruction.

If the balance of currency B of the account at the time of repayment is less than the repayment amount (including interest) when converted to the appraisal value in currency X, the shortfall payment processing unit 114 performs a process for paying the shortfall. It may, for example, purchase and pay coins in currency B in legal currency (currency X) for payment of shortfalls, may pay the currency X to a bank account or the like designated by the system, and may pay by using a payment means such as a credit card.

==Management Server 2==

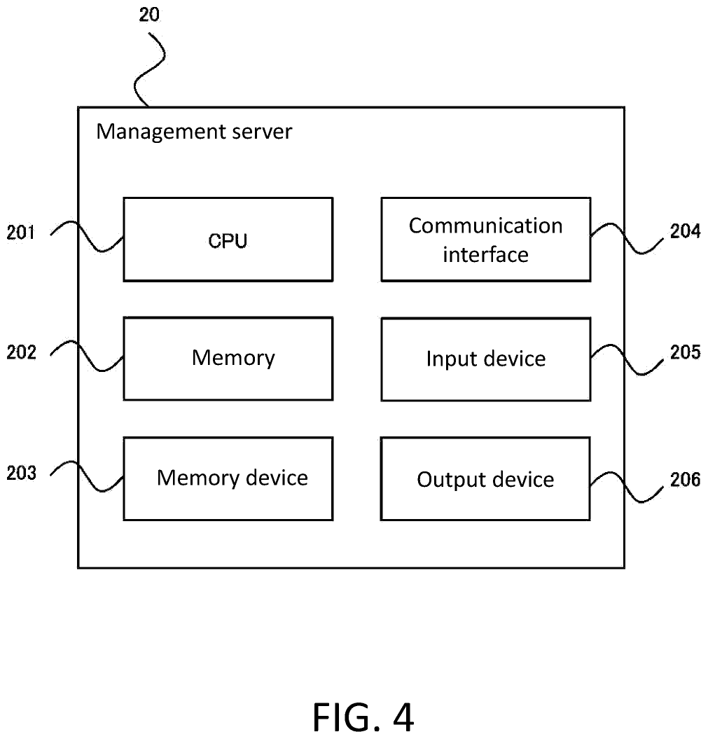

FIG. 4 shows the hardware configuration example of management server 2. The management server 2 includes a CPU 201, a memory 202, a storage device 203, a communication interface 204, an input device 205, and an output device 206. The storage device 203 is, for example, a hard disk drive, a solid-state drive, a flash memory and the like, which stores various data and programs. The communication interface 204 is an interface for connecting to the communication network 3, and for example, includes an adapter for connecting to a Ethernet (registered trademark), a modem for connecting to a public telephone network, a wireless communication device for wireless communication, USB (Universal Serial Bus) connector and RS232C connector for serial communication, and the like. The input device 205 is, for example, a keyboard, a mouse, a touch panel, a button, a microphone, or the like that inputs data. The output device 206 is, for example, a display, a printer, a speaker, or the like that outputs data.

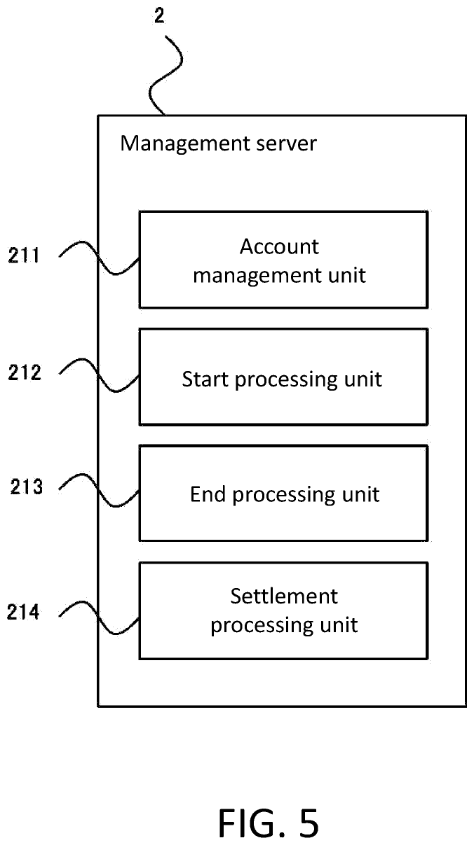

FIG. 5 shows the software configuration example of management server 2. As shown in the figure, the management server 2 includes an account management unit 211, a start processing unit 212, an end processing unit 213, and a settlement processing unit 214.

The account management unit 211 manages the user's account. The account management unit 211 can store accounts for all users in the storage area of the memory 201 or the storage device 203 to acquire information such as the balance of each user's account. In the present embodiment, the account management unit 211 detects that the currency A has been deposited in the user's account. When currency A has been deposited into the user's account, the account management unit 211 deposits currency B into the user's account. The account management unit 211 converts the amount of currency A deposited in the user's account into the value of currency X (legal currency), and determines the value to be lent to the user (hereinafter referred to as the loan price) according to the converted value (hereinafter referred to as the deposit price). In the present embodiment, it is assumed that the loan price is larger than the deposit price, and for example, the loan price is the upper limit of the amount obtained by multiplying the deposit price by the leverage such as 2 times, 5 times, 10 times, 25 times, and the like. The account management unit 211 can determine the loan price (that is, the credit amount to the user) which is equal to or less than the above upper limit. The user determines a desired amount equal to or less than the above upper limit, and sets the desired amount in the above message transmitted from the user terminal 1. The account management unit 211 acquires, for example, credit information of the user and can determine a loan price according to the credit information and the desired amount. The account management unit 211 converts the determined loan price of currency X into the value of currency B, and converts it into the value of currency B, and performs a process for depositing the virtual currency of the currency B corresponding to the converted value into the user's account. The account management unit 211 can make a deposit, for example, by creating a transaction for moving coins from the system operator's account to the user's account. Further, the account management unit 211 may issue a new currency B or purchase the currency B in the legal tender X to deposit it in the user's account.

The start processing unit 212 performs processing related to the start of staking. In the present embodiment, when the currency B corresponding to the currency A (with effective leverage) is deposited into the account, staking for the currency B is started. The start of staking can be performed, for example, by creating a node using a predetermined number of coins of currency B and registering the node in the blockchain network 4 pertaining to currency B. The start processing unit 122 may also start staking for the currency A.

The end processing unit 213 performs a process for ending the operation of staking in the blockchain network 4. For example, the end processing unit 213 transmits a message to the effect that staking is to be ended to the blockchain network 4, and receives a message from the blockchain network 4 to the effect that the staking is ended, thereby ending the staking. That is, the end processing unit 123 can disconnect the node from the blockchain network 4 and unlock the coins (currency A and currency B) of the account (capable of fund transfer).

The settlement processing unit 214 performs settlement processing according to the above loan price. The settlement processing unit 214 calculates the value (hereinafter referred to as repayment amount) obtained by adding a predetermined interest to the value (i.e., loan value) of currency X of currency B deposited in the account at the time of loan (at the start of staking). Here, the settlement processing unit 214 can determine the interest, for example, depending on at least one of currency B's volatility, hash rate, number of transactions, lock rate, reward rate, exchange-based transaction amount, and market capitalization. For example, the settlement processing unit 214 can calculate the amount of interest by multiplying the loan price by the interest rate corresponding to at least one of currency B volatility, hash rate, number of transactions, lock rate, reward rate, exchange-based transaction amount, and market capitalization. The settlement processing unit 214 transmits, to the user terminal 1, a repayment instruction in which the repayment amount is set so as to repay the calculated repayment amount, so that the currency B corresponding to the repayment amount from the account is withdrawn. The withdrawal destination can be, for example, the account of the system operator.

==Processing==

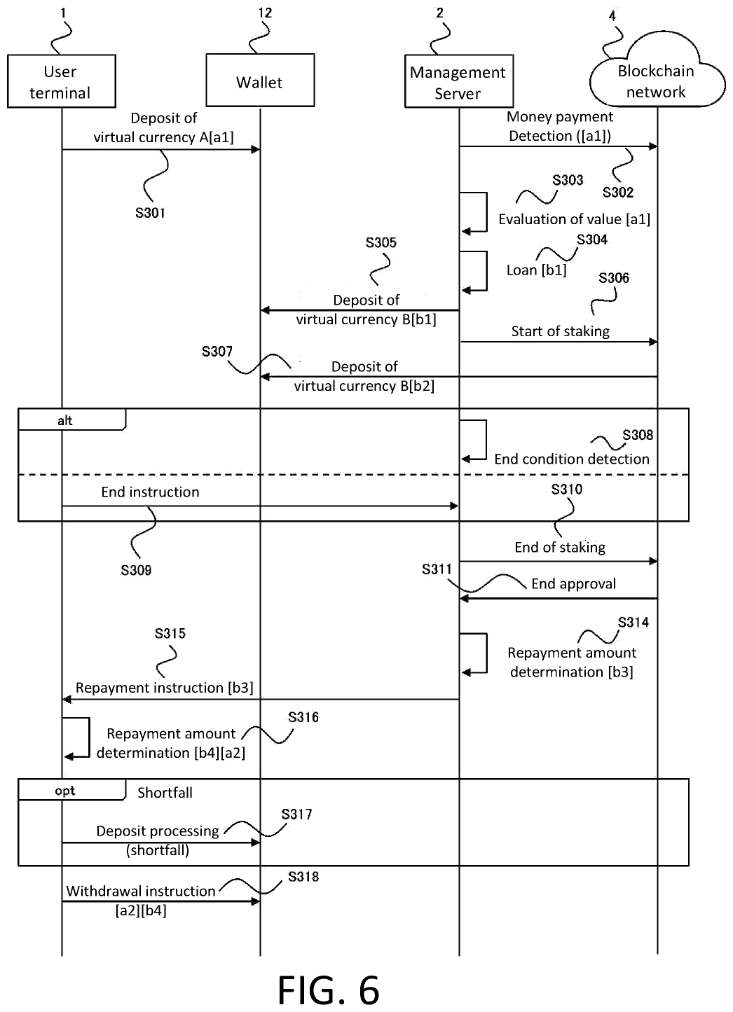

FIG. 6 is a figure for explaining the operation of the staking system of the present embodiment.

The deposit processing unit 111 of the user terminal 1 deposits “a1” units of the currency A to the account corresponding to the wallet 12 in accordance with an instruction from the user (S301). The account management unit 211 of the management server 2 detects that money payment of “a1” units has been made (S302).

When the account management unit 211 detects the deposit, it converts “a1” units of currency A into the value in the currency X (S303), and determines the loan price according to the value in the converted currency X (that is, calculates the credit amount to the user) (S304). The account management unit 211 converts the loan price into the value “b1” of the currency B, and deposits the “b1” units of the currency B into the user's account (S305).

The start processing unit 212 of the management server 2 starts staking of currency B in the blockchain network 4 (S306). For example, staking can be performed by creating a node using “b1” units of currency B and deploying it in the blockchain network 4. In blockchain network 4, if minting by staking is successful, the reward (e.g., “b2” units) is paid to the user's account (S307).

Here, the end processing unit 213 performs a process for ending the staking operation in the blockchain network 4 when a predetermined end condition is detected (S308) such as when the value converted by the account management unit 211 into currency X of currency B of “b1+b2” is less than a predetermined amount as an example; or when the prescribed staking operation period has expired, etc., or when the end instruction unit 112 receives an instruction from the user to end the staking and transmits the end instruction to the management server 2 (S309). The end processing unit 213 transmits, for example, a message to the effect that staking is ended to the blockchain network 4 (S310). The staking can be ended by receiving a message from the blockchain network 4 to the effect that the end of staking has been approved (S311).

The settlement processing unit 214 of the management server 2 calculates the repayment amount “b3” according to the loan amount (S314). For example, depending on at least one of currency B's volatility, hash rate, number of transactions, lock rate, reward rate, exchange-based transaction amount, and market capitalization, the settlement processing unit 214 may calculate the interest according to the pre-set interest rate, the loan amount, and the period from the start to the end of staking, and add the interest to the loan amount to calculate the repayment amount. Then, the settlement processing unit 214 converts the repayment amount into the value “b3” of the currency B. The settlement processing unit 214 transmits a repayment instruction set to “b3” to the user terminal 1 (S315).

The withdrawal processing unit 113 of the user terminal 1 calculates the amount “b4” of the currency B to be withdrawn from the account and the amount “a2” of the currency A to be withdrawn from the account, in accordance with the value “b3” of currency B equivalent to the repayment amount set in the repayment instruction (S316). If the value “b3” of currency B equivalent to the repayment amount is less than or equal to the balance “b1+b2” of currency B of the account, b4 is calculated by b1+b2−b3, and a2 is 0 (zero). If the value “b3” of currency B equivalent to the repayment amount is larger than the balance “b1+b2” of currency B of the account, b4 is calculated by b3−b1=b2. The withdrawal processing unit 113 converts the balance b3−b4 into the amount “a2” of the currency A. Here, if “a2” is larger than the balance “a1” of the currency A of the account, the shortfall payment processing unit 114 performs payment processing (S317) with respect to the shortfall “a2−a1”. As mentioned above, for the payment of the shortfall, for example, coins of currency B may be purchased and paid in the legal currency (currency X). The currency X can be paid to the bank account specified by the system, or payment may be made using a payment method such as a credit card. Finally, the withdrawal processing unit 113 creates a transaction so that the currency A of “a2” and the currency B of “b4” are withdrawn from the account corresponding to the wallet 12 (S317), and the loan amount is repaid with interest.

==Summary==

As described above, the following processing is performed in the staking system of the present embodiment.

1. The user deposits the virtual currency A in the wallet 12.

2. The system operator uses virtual currency A as collateral, converts the value of the collateral in legal tender X, lends virtual currency B complying with the value to the user, stakes virtual currency B, and increases the total amount of virtual currency B. The reward obtained by this staking will be applied to the wallet 12 within a certain period of time.

3. When the staking operation is ended at an arbitrary timing, the staking ends at a point of time when the blockchain network 4 approves the operation.

4. The user repays the loan based on the value of the virtual currency B at the time of borrowing by adding a predetermined corresponding interest. The repayment is initially made in virtual currency B, and if it is insufficient, payment is also made from virtual currency A.

For example, if the value of virtual currency B at the time of borrowing is 5 million yen and a corresponding interest is 10%, the user is obliged to return virtual currency B (or virtual currency A) corresponding to 5.5 million yen.

Here, if (i) the value of the virtual currency B to be returned by the user>the current value of the virtual currency B owned by the user, the user cannot repay the entire repayment amount only with the virtual currency B the user owns, and is obliged to repay the shortfall. In repayment of the shortfall, payment is made from the virtual currency A provided as collateral. If there is a shortage that cannot be covered by virtual currency A, the user must deposit the shortage of virtual currency B.

Meanwhile, if (ii) the value of the virtual currency B to be refunded by the user<the current value of the virtual currency B owned by the user, the user repays all the repayment amount from the virtual currency B held by the user, and the balance of the virtual currency B still remaining at the time when the user performs all the obligations to be repaid becomes the user's profit.

If the value of the virtual currency A provided by the user as collateral has fallen to a certain extent, staking can be forcibly ended at that point. At this time, the processing of (i) (ii) above is performed.

Next, an example of a specific amount of money is shown.

(1) The user deposits a virtual currency A having a value of 100 into the account.

(2) The system operator lends the virtual currency B having a value of 300 to the user, and the account of the user to which the virtual currency B is deposited is locked.

(3) Staking is executed using the virtual currency B having a value of 300 deposited in the user's account.

Here, it is assumed that the value of the virtual currency B deposited by the user has decreased to 50.

(4) In this case, the virtual currency B deposited by the user has become the value of 50. If this decrease exceeds the threshold, staking is forcibly ended.

(5) The value of the virtual currency B lent to the user from the system was 300. Therefore, 250 is a shortage.

(6) In this case, the repayment is made from the virtual currency A (the value is unchanged at 100) acquired as collateral, and the user procures the virtual currency B and makes the repayment for the rest 150.

As described above, according to the staking system of the present embodiment, the user can perform staking with the amount of the currency B that has been leveraged effectively by depositing the currency A. Therefore, the reward for staking can be obtained more efficiently.

Although the present embodiment has been described above, the above embodiment is for facilitating the understanding of the present invention, and is not for limiting the interpretation of the present invention. The present invention can be modified and improved without departing from the spirit thereof, and the present invention also includes an equivalent thereof.

For example, in the present embodiment, the wallet 12 is a contract wallet, but the wallet 12 is not limited thereto, and may be a custody wallet managed by the system side. In this case, the wallet 12 is not provided on a user terminal 1, but is provided on a management server 2.

Further, in the present embodiment, the staking of currency B is operated while being owned by the user, but the owner of the wallet 12 may be the system operator and the staking may be operated by the operator. In this case as well, the wallet 12 can be provided by the management server 2.

Further, in the present embodiment, staking is performed only for currency B, but staking can be performed for currency A as well.

In addition, in the present embodiment, it is assumed that the asset management of currency B is performed by staking of virtual currency, but it can be managed by stocks, corporate bonds, lending (loan) on the blockchain 4, or the like.

Also, the risk tolerance of the user may be taken into consideration. In this case, the profit margin for a given lock period is estimated based on the statistic value of the staking virtual currency (currency B) (including at least one of volatility, hash rate, number of transactions, and lock rate), and it may be decided whether or not to operate by staking in accordance with the estimated profit margin, the risk tolerance, and the interest rate concerning the loan. In this case, when it is decided not to operate, the account management unit 211 may prevent the loan from being made (payment of the loan price is not made).

Further, in the present embodiment, it is assumed that there is only one type of currency B for staking, but when it is possible to operate with multiple virtual currencies B, the profit margin for each virtual currency can be estimated and the account can be credited with the virtual currency with the highest profit margin so that staking is done by the virtual currency with the highest profit margin.

Additionally, in the present embodiment, the settlement is performed after the lock period concerning staking is ended, but before the end of the lock period, the amount subtracted a predetermined fee is paid to the user, and the ownership of the wallet 12 may be transferred to the system operator.

### DESCRIPTION OF REFERENCE NUMERALS

1: user terminal
2: management server
3: communication network
4: blockchain network
12: wallet 12
111: deposit processing unit
112: end instruction unit
113: withdrawal processing unit
114: shortfall payment processing unit
121: private key
211: account management unit
212: start processing unit
213: end processing unit
214: settlement processing unit

1. A virtual currency operation method,
wherein a computer performs:
a step of converting an amount of currency A deposited to a user's first account into a deposit price, which is a price in currency X, calculating a loan price for lending to the user with the currency A in the first account as collateral according to the converted deposit price, and processing to deposit currency B, a virtual currency, equivalent to the loan price, into the second account corresponding to the user;
a step of performing a process for operating staking pertaining to the currency B using the currency B deposited in the second account, and
a step of calculating a repayment price, which is the price in the currency X obtained by adding at least interest to the loan price, after the end of the staking, and performing a process for withdrawing the currency B corresponding to the repayment price from the second account.

2. The virtual currency operation method according to claim 1,
wherein the computer further performs:
a step of, when the balance of the currency B in the second account is less than the amount corresponding to the loan price after the end of the staking, processing of withdrawing the currency A corresponding to the value of the shortfall from the first account.

3. The virtual currency operation method according to claim 2,
wherein the computer further performs:
a step of, when there is a second shortfall that cannot be covered by the currency A for the first shortfall that is the deficiency, performing a process for depositing the currency B corresponding to the value of the second shortfall into the second account.

4. The virtual currency operation method according to claim 1, the method further performs:
a step of acquiring the collateral value of the balance of the currency A converted into the currency X; and
a step of ending the staking when the collateral value is less than or equal to a predetermined value.

5. The virtual currency operation method according to claim 4,
wherein the predetermined value is determined according to the loan price.

6. The virtual currency operation method according to claim 1,
wherein characterized the computer determines the interest according to a statistic value concerning the virtual currency of the currency B.

7. The virtual currency operation method according to claim 6,
wherein the statistic value includes at least one of the volatility, hash rate, number of transactions, and lock rate, reward rate, exchange-based transaction amount, and market capitalization, pertaining to the currency B.

8. The virtual currency operation method according to claim 1,
wherein the computer further performs a step of selecting currency B from a plurality of virtual currencies in accordance with at least one of reward rate by staking, exchange-based transaction amount, volatility, hash rate, number of transactions, lock rate, and market capitalization.

9. The virtual currency operation method according to claim 1,
wherein the computer further performs:
a step of, after the reward by the staking has been deposited to the second account, exchanging the currency B deposited in the account for a virtual currency different from the currency B according to the amount concerning the reward converted into the value of the currency X, and executing a process for operating staking pertaining to the different virtual currency.

10. The virtual currency operation method according to item 1,
wherein the computer performs:
after the end of the staking before the lock period elapses, a process for paying the user an amount obtained by subtracting a fee from the locked balance of the currency B.

11. The virtual currency operation method according to claim 1,
wherein the computer determines whether or not to deposit the loan price into the second account according to the rate of return for the staking pertaining to currency B and the interest rate concerning interest.

12. The virtual currency operation method according to claim 1,
wherein the computer determines whether or not to deposit the loan price into the second account, depending on the rate of return by staking pertaining to currency B, the rate of return for the interest, and the risk tolerance of the user specified in advance.

13. The virtual currency operation method according to claim 1,
wherein the currency B is a security token.

14. The virtual currency operation method according to in claim 1,
wherein the computer further performs:
a step, in which the currency A is a virtual currency, of performing a process for operating the staking pertaining to the currency A.
